(19) United States
(12) Patent Application Publication
(10) Pub. No.: US 2026/0162410 A1
(43) Pub. Date: Jun. 11, 2026

(54) METHOD FOR AUTOMATICALLY EXTRACTING JET STREAM AXIS BASED ON SEMI-SUPERVISED LEARNING WITH CROSS PSEUDO-SUPERVISION

(71) Applicant: Chengdu University of Information Technology, Chengdu (CN)

(72) Inventors: Jianhong Gan, Chengdu (CN); Wendong Hu, Chengdu (CN); Hongping Shu, Chengdu (CN); Zhiliang Shu, Chengdu (CN); Peiyang Wei, Chengdu (CN); Chunjiang Wu, Chengdu (CN); Zhibin Li, Chengdu (CN); Zezhong Wu, Chengdu (CN); Tongli He, Chengdu (CN); Huabing Feng, Chengdu (CN); Qiang Zhang, Chengdu (CN); Kun Cai, Chengdu (CN); Yuanyuan Zheng, Chengdu (CN); Qiao Zeng, Chengdu (CN); Jinyu Zhang, Chengdu (CN); Yu Peng, Chengdu (CN); Wenjie Zhou, Chengdu (CN)

(21) Appl. No.: 19/408,164

(22) Filed: Dec. 3, 2025

(30) Foreign Application Priority Data
Dec. 11, 2024 (CN) 202411818362.1

(51) Int. Cl. G06V 10/774; G01W 1/10; G06V 10/26; G06V 10/72; G06V 10/77; G06V 10/776; G06V 10/82

(52) U.S. Cl. CPC G06V 10/7753; G01W 1/10; G06V 10/26; G06V 10/72; G06V 10/7715; G06V 10/776; G06V 10/82

(57) ABSTRACT

Disclosed is a method for automatically extracting a jet stream axis based on semi-supervised learning with cross pseudo-supervision. The method includes: preprocessing acquired 11 types of grid-point wind field data and performing label mask conversion on manually labeled data; constructing a semi-supervised deep learning model with cross pseudo-supervision; training and evaluating the semi-supervised deep learning model with cross pseudo-supervision by using a preprocessing result and a label mask conversion result, and obtaining an image segmentation result according to the evaluated semi-supervised deep learning model with cross pseudo-supervision; and extracting the jet stream axis by using an eight-neighborhood connection algorithm based on a jet stream center axis point according to the image segmentation result. The present application addresses the defects of the manual drawing method of the jet stream axis in the current meteorological field of low efficiency, high error, and strong subjectivity, making it difficult to achieve efficiency and accuracy.

### CROSS-REFERENCE TO RELATED APPLICATIONS

This application claims priority to Chinese Patent Application No. 202411818362.1, filed on Dec. 11, 2024, which is hereby incorporated by reference in its entirety.

### TECHNICAL FIELD

The present application belongs to the field of meteorological technologies, and in particular, to a method for automatically extracting a jet stream axis based on semi-supervised learning with cross pseudo-supervision.

### BACKGROUND

The atmospheric jet stream refers to a narrow and strong wind belt with relatively high wind speed in the atmosphere, which usually appears in the middle and upper levels of the atmosphere and has a significant influence on weather systems and surface weather. In weather forecasting, a jet stream axis is a key indicator used to represent the center line of the jet stream, which helps meteorologists intuitively understand the weather pattern and make predictions. The traditional drawing of a jet stream axis mainly relies on manual operation, in which forecasters manually draw the jet stream axis through the Meteorological Information Comprehensive Analysis and Processing System (MICAPS). This manual approach not only results in low efficiency but also introduces subjectivity, leading to significant errors. To improve the level of automation, researchers attempt to automatically extract jet stream axes from radar data and grid-point wind field data. Existing methods are primarily based on mathematical models and algorithms, such as merging algorithms, polynomial fitting, key point detection, and thresholding techniques. Despite having reduced subjectivity to some extent and improved the level of automation, these methods still struggle to achieve high precision extraction when faced with complex atmospheric wind fields, especially in cases of jet stream bifurcation or merging. Furthermore, the stability and generalization ability of these methods are limited under different wind field conditions.

In recent years, deep learning technology, with the strong performance in image recognition and pattern classification, has gradually been applied to the meteorological field, particularly in the task of automatically extracting jet stream axes. Fully supervised learning requires a large amount of high-quality labeled data, which creates significant limitations in practical applications. To overcome the data dependency problem, semi-supervised learning has become an effective solution, which can perform model training using a large amount of unlabeled data with a small amount of labeled data, thereby improving the generalization ability of the model.

With the development of semi-supervised learning methods, consistency learning and cross pseudo-supervision techniques have gradually attracted attention. Adding perturbations to unlabeled data and comparing the perturbed data with the non-perturbed data can improve the robustness and accuracy of the model. However, existing pseudo-supervision methods typically only use pseudo labels for auxiliary supervision, without effectively incorporating the pseudo labels into the training process, which limits further improvement of model performance. How to make full use of unlabeled data and improve the accuracy and efficiency of automatic extraction of jet stream axes has become a key direction of current technological development.

### SUMMARY

Aiming at the foregoing defects in the prior art, the present application provides a method for automatically extracting a jet stream axis based on semi-supervised learning with cross pseudo-supervision. The present application solves the problems of low efficiency and poor generalization ability of traditional jet stream axis extraction methods by combining semi-supervised learning and an eight-neighborhood connection algorithm based on the jet stream center axis point, while reducing dependence on labeled data and improving the accuracy and robustness of jet stream axis recognition.

To achieve the foregoing objective, the present application adopts the following technical solutions. A method for automatically extracting a jet stream axis based on semi-supervised learning with cross pseudo-supervision includes the following steps:
S1. preprocessing acquired 11 types of grid-point wind field data and performing label mask conversion on manually labeled data;
S2. constructing a semi-supervised deep learning model with cross pseudo-supervision;
S3. training and evaluating the semi-supervised deep learning model with cross pseudo-supervision by using a preprocessing result and a label mask conversion result in the step S1, and obtaining an image segmentation result according to the evaluated semi-supervised deep learning model with cross pseudo-supervision; and
S4. extracting the jet stream axis by using an eight-neighborhood connection algorithm based on a jet stream center axis point according to the image segmentation result.

Further, the S1 includes the following steps:
S101. acquiring 11 types of grid-point wind field data;
S102. calculating wind speed and wind direction for each grid point, where the accuracy of a direction angle is determined by adjusting a quadrant of the wind speed;
S103. mapping the calculated wind speed and wind direction to RGB three-channel data, obtaining wind field image encoding data, and completing preprocessing of wind field processing data, where the R channel data represents a magnitude of the wind speed mapped to a value range of a R channel in a color image through encoding, the G channel data and the B channel data represent wind directions mapped to value ranges of a G channel and a B channel in a color image through encoding, respectively, and the wind field image encoding data includes labeled data and unlabeled data;
S104. reading a label mask based on the manually labeled data;
S105. extracting all connected target area lines from the label mask to obtain a contour of the label mask;
S106. performing random selection and transformation on the contour of the label mask to obtain a retained contour; and
S107. redrawing and generating a new label mask based on the retained contour, saving the new label mask, and completing the label mask conversion processing.

Further, an expression for the wind speed is as follows:

$$Speed = \sqrt{{U}^{2} + {V}^{2}}$$

where Speed represents the wind speed, and U and V represent wind speed components;
an expression for the wind direction is as follows:

$$Direction = \{ \begin{matrix}0 , & U = 0 , V \geq 0 \\ 90 , & U > 0 , V = 0 \\ 270 , & U < 0 , V = 0 \\ 180 , & U = 0 , V < 0 \\ arctan ( \frac{U}{V} ) \times \frac{180}{π} , & U > 0 , V > 0 \\ arctan ( − \frac{V}{U} ) \times \frac{180}{π} + 270 , & U ( 0 , V ) 0 \\ arctan ( − \frac{V}{U} ) \times \frac{180}{π} + 90 , & U > 0 , V < 0 \\ arctan ( \frac{U}{V} ) \times \frac{180}{π} + 180 , & U > 0 , V > 0\end{matrix}$$

where Direction represents the wind direction.

Further, mapping the calculated wind speed and wind direction to the RGB three-channel data is specifically as follows:
mapping the calculated wind speed and wind direction to the RGB three-channel data by using the following formula:

$${R}_{( i , j )} = \{ \begin{matrix}0 , {Speed}_{( i , j )} < 14 \\ \frac{255}{1 + {e}^{− {Speed}_{( i , j )} + 20}} {Speed}_{( i , j )} \leq 14\end{matrix}$$

$${G}_{( i , j )} = [ cos ( \frac{2 \times π \times {Direction}_{( i , j )}}{359} ) + 1 ] \times 127.5$$

$${B}_{( i , j )} = [ sin ( \frac{2 \times π \times {Direction}_{( i , j )}}{359} ) + 1 ] \times 127.5$$

where R_{(i,j)} represents a magnitude of wind speed at a position of (i, j) types of grid-point wind field data from the MICAPS, which is mapped to a R channel value at a pixel (i, j) of a color image through encoding, G_{(i,j)} and B_{(i,j)} represent wind directions at the position (i, j) of 11 types of grid-point wind field data from the MICAPS, which are mapped to a G channel value and a B channel value at the pixel (i, j) of the color image through encoding, respectively, Speed_{(i,j)} represents a magnitude of the wind speed at the position (i, j) of 11 types of grid-point wind field data from the MICAPS, and Direction_{(i,j)} represents the wind direction at the position (i, j) of 11 types of grid-point wind field data from the MICAPS.

Further, the semi-supervised deep learning model with cross pseudo-supervision includes:
a first Swin-Unet network, configured to convert the preprocessing result and the label mask conversion result in the step S1 into a predicted first jet stream region mask;
a second Swin-Unet network, configured to convert the preprocessing result and the label mask conversion result in the step S1 into a predicted second jet stream region mask, where the first Swin-Unet network and the second Swin-Unet network adopt different initialization processes; and
a cross pseudo-supervision module, configured to generate a first pseudo label and a second pseudo label as mutual supervision signals based on the first jet stream region mask and the second jet stream region mask, thereby obtaining the image segmentation result, where each batch includes labeled and unlabeled data, and in each training batch, the semi-supervised deep learning model with cross pseudo-supervision updates weights using the labeled data while guiding the learning of the unlabeled data through pseudo labels.

Further, the first Swin-Unet network and the second Swin-Unet network have identical structures and both include:
an encoder, configured to partition the preprocessing result and the label mask conversion result in the step S1 into non-overlapping windows using a plurality of Swin Transformer modules to extract deep features, where a self-attention mechanism is applied within each window;
a bridging module, configured to connect an encoder and a decoder;
a decoder, configured to restore the extracted deep features to the same resolution as an input image through layer-wise upsampling, where the input image is the preprocessing result and the label mask conversion result in the step S1; and
an output layer, configured to convert an image output from the decoder into a predicted jet stream region mask using convolutional layers, where the jet stream region mask includes the first jet stream region mask and the second jet stream region mask.

Further, an expression for a supervised learning loss function of the semi-supervised deep learning model with cross pseudo-supervision is as follows:

$${L}_{Sup} = λ {L}_{CE} + μ {L}_{Dice}$$

$${L}_{CE} = - {{\sum }_{i}}^{C} {y}_{i} log ( \hat{y} )$$

where L_{Stop} represents the supervised learning loss function of the semi-supervised deep learning model with cross pseudo-supervision, λ and μ represent weight coefficients, L_{CE} represents a cross-entropy loss function, L_{Dice} represents a Dice loss function, represents a total number of categories, yᵢ represents a ground truth label, and ŷ represents a probability of prediction belonging to category i.

Further, the step S4 includes the following steps:
S401. based on the image segmentation result, locating a starting pixel, where only one neighboring pixel in eight-neighborhood around the starting pixel has a color value;
S402. traversing the eight-neighborhood of the starting pixel, preferentially selecting a neighboring pixel that is closest to a current point and has not been accessed, and marking the neighboring pixel as accessed;
S403. with the starting pixel as a center, determining whether all neighboring pixels have been traversed, if so, sequentially adding each neighboring pixel to a set of connected jet stream axis center points and proceeding to step S404, and otherwise, returning to the step S402; and
S404. based on the jet stream axis center point set, drawing a jet stream line to complete the extraction of the jet stream axis.

The beneficial effects of the present application are as follows.

(1) Compared with traditional fully supervised learning or manual processing methods, the present application solves the problems of low efficiency and poor generalization ability of traditional jet stream axis extraction methods by combining semi-supervised learning and an eight-neighborhood connection algorithm based on the jet stream center axis point, while reducing dependence on labeled data and improving the accuracy and robustness of jet stream axis recognition.

(2) In terms of data security, the present application integrates the jet stream axis recognition process and pseudo label generation entirely within a local deep learning framework, which reduces reliance on cloud computing and data transmission, thereby mitigating the risk of sensitive data leakage. Due to the involvement of important meteorological data such as high-altitude wind fields during the training process, local training ensures that the data remains within the local environment, thereby enhancing the data security of the system.

(3) In semi-supervised learning, the present application fully utilizes a large amount of unlabeled data, which does not require labeling, transmission, or manual organization. This avoids the risk of traditional meteorological label data leakage, further ensuring the confidentiality of the data.

(4) The present application, through the cross pseudo-supervision mechanism, combines unlabeled data with a small amount of labeled data, significantly reducing reliance on expensive labeled data. Compared to traditional fully supervised models, the present application reduces the cost of manual labeling, the amount of labeled data transmission, and the overall demand for labeled data.

(5) The present application achieves efficient computation through hierarchical convolution and self-attention mechanisms by using the Swin-Unet network architecture. The Swin-Unet network supports operation on resource-constrained edge devices, avoiding the high consumption of cloud computing resources and achieving a lightweight architecture with support for distributed computing.

(6) During the training process, the present application designs a dynamic consistency loss function, which gradually adjusts the consistency weight based on the training progress, reduces unnecessary iterations, improves training efficiency, and thereby reduces the consumption of computational resources and time, achieving the optimization of dynamic consistency loss.

(7) The present application uses two Swin-Unet networks with different initializations to generate pseudo labels for each other. The generalization ability of the model in complex atmospheric wind fields is enhanced through pseudo-supervised training. This strategy effectively reduces the impact of low-quality pseudo labels, prevents the model from falling into local optima, and achieves improved model robustness through cross pseudo-supervision.

(8) The present application obtains the jet stream axis through skeleton extraction technology, and significantly improves the generalization ability of the model and the accuracy of jet stream axis extraction by using a semi-supervised learning strategy along with a large amount of unlabeled data.

(9) The present application implements an efficient, low-cost, and secure jet stream axis recognition solution through key technologies such as cross pseudo-supervision and dynamic consistency optimization. Compared with traditional fully supervised learning models and manual recognition methods, the present application offers significant advantages in terms of data security, network resource savings, real-time performance, and generalization ability. These features enable the present application to achieve more efficient applications in complex atmospheric environments, providing reliable technical support for meteorological monitoring and aviation safety. In terms of automated recognition with reduced human intervention, the jet stream axis recognition system of the present application achieves a fully automated process from data input to model output, eliminating the need for manual involvement and significantly reducing the time for human intervention. In terms of real-time processing capability, the semi-supervised deep learning model with cross pseudo-supervision of the present application may be integrated into real-time monitoring systems at meteorological stations, ensuring timely detection and dynamic updates of the jet stream axis, providing real-time support for aviation flight, weather forecasting, and emergency response.

### BRIEF DESCRIPTION OF THE DRAWINGS

FIG. 1 is a flowchart of the method of the present application.

FIG. 2 is a flowchart of the present application.

FIG. 3 is a block diagram of a semi-supervised deep learning model with cross pseudo-supervision according to an embodiment.

FIG. 4 is a schematic diagram of jet stream axis extraction using an eight-neighborhood connection algorithm based on a jet stream center axis point according to an embodiment.

### DESCRIPTION OF EMBODIMENTS

The following description of the specific embodiments of the present application is provided to facilitate the understanding of the present application by those skilled in the art, however, it should be understood that the present application is not limited to the scope of the specific embodiments, and for those of ordinary skill in the art, various changes that are made without departing from the spirit and scope of the present application as defined and determined by the appended claims are apparent, and all inventions and creations that are made by using the concept of the present application are within the protective scope.

### Embodiment

Before describing the present application, the following terms are explained:

In the Swin-Unet network, “Swin” refers to Swin Transformer, which is a type of Shifted Window (Swin). The Swin Transformer refers to the Transformer model with a Shifted Window. Transformer is a neural network architecture. Therefore, the Swin-Unet network is a network model that replaces part of the encoder and decoder structures in Unet with the Swin Transformer. The 11 types of grid-point wind field data are grid-point vector data, mainly used for drawing wind field streamlines. The data contains four pieces of information at each grid point: longitude, latitude, U component, and V component.

Currently, in the meteorological field, the manual drawing method of the jet stream axis has the defects of low efficiency, high error, and strong subjectivity, making it difficult to meet the demands for efficiency and accuracy. Although some automated methods have attempted to extract the jet stream axis from radar data and wind field data, traditional methods based on mathematical and mechanistic analysis suffer from insufficient generalization ability and low recognition accuracy when processing complex wind fields, and particularly have poor performance especially in scenarios of jet stream bifurcation and merging. In addition, existing fully supervised learning models have a high demand for high-quality labeled data, which limits the widespread adoption of this model in practical applications. Therefore, how to improve the automation level, accuracy, and generalization ability of jet stream axis extraction while reducing reliance on large amounts of labeled data by using deep learning models is a major issue currently faced in the technical field.

The present application provides a semi-supervised deep learning model for automatic jet stream axis extraction based on a cross pseudo-supervision method, which aims to achieve efficient, automated, and accurate extraction of the jet stream axis through improved semi-supervised deep learning techniques. This model generates pseudo labels using a small amount of labeled data and a large amount of unlabeled data by introducing the cross pseudo-supervision (CPS) strategy, thereby improving robustness and generalization ability. Specifically, according to the present application, Swin-Unet is used as the backbone network, combined with consistency learning methods and the eight-neighborhood connection algorithm based on the jet stream center axis point, so that the semi-supervised deep learning model for automatic jet stream axis extraction can effectively handle complex wind field scenarios in jet stream region recognition. Through this model, the precise extraction of the jet stream axis may be achieved with reduced reliance on labeled data, improving overall efficiency and recognition performance. Therefore, this model is widely applicable to jet stream detection and prediction tasks in the meteorological field.

In this embodiment, the CPS strategy uses two Swin-Unet networks (differently initialized networks), and even though the inputs are the same, the two models generate different prediction results due to different initialization modes (such as Kaiming and Xavier initialization). This structure lays the foundation for consistency learning: the prediction results of different models on the same data should remain consistent. In the CPS strategy, the prediction result of the first Swin-Unet network is used as a pseudo label to supervise the second Swin-Unet network. Similarly, the prediction result of the second Swin-Unet network serves as a pseudo label to supervise the first Swin-Unet network. This interactive training method is an embodiment of consistency learning: the learning directions of the two Swin-Unet networks are constrained through the pseudo labels, so that the predictions of the two Swin-Unet networks tend to be consistent even if some data lacks true labels.

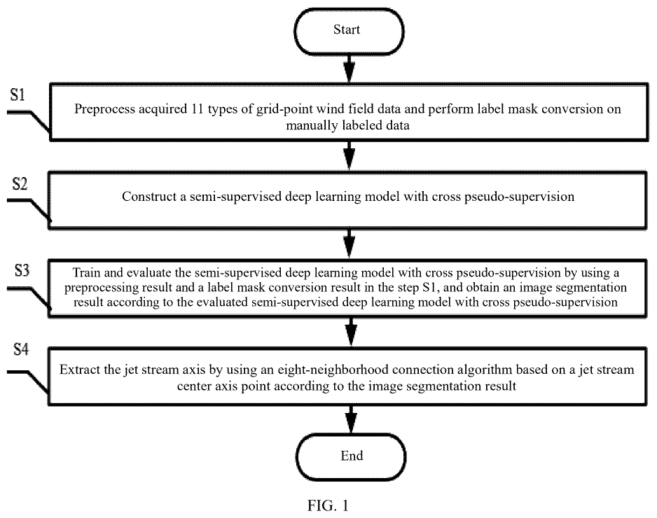

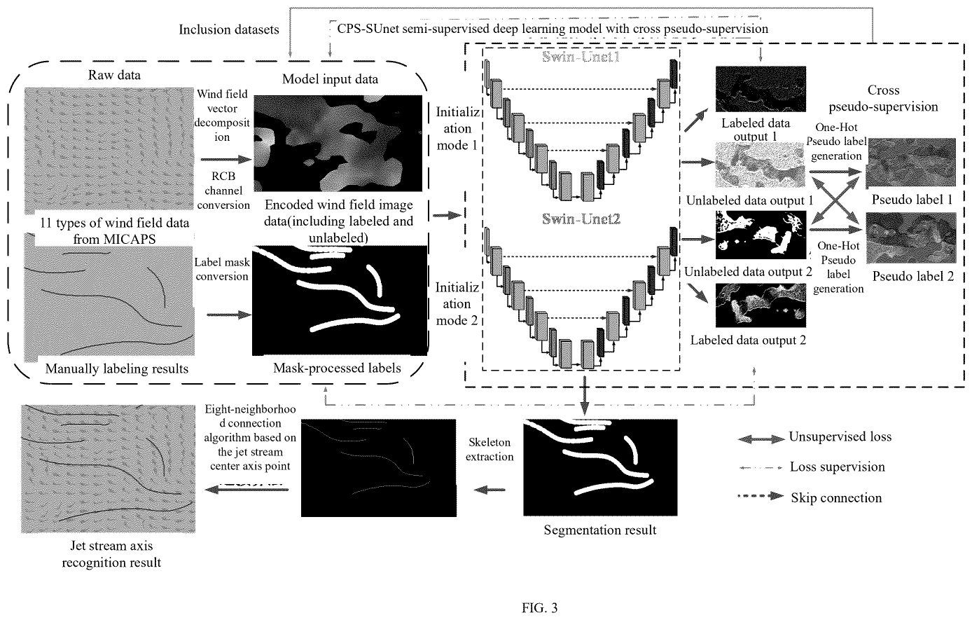

As shown in FIGS. 1, 2 and 3, the present application provides a method for automatically extracting a jet stream axis based on semi-supervised learning with cross pseudo-supervision. This method is implemented by steps S1 to S4.

In the step S1, the acquired 11 types of grid-point wind field data are preprocessed, and label mask conversion is performed on manually labeled data. The step S1 is implemented as follows:
S101. acquiring 11 types of grid-point wind field data;
S102. calculating wind speed and wind direction for each grid point, where the accuracy of a direction angle is determined by adjusting a quadrant of the wind speed;
S103. mapping the calculated wind speed and wind direction to RGB three-channel data, obtaining wind field image encoding data, and completing preprocessing of wind field processing data, where the R channel data represents a magnitude of the wind speed mapped to a value range of a R channel in a color image through encoding, the G channel data and the B channel data represent wind directions mapped to value ranges of a G channel and a B channel in a color image through encoding, respectively, and the wind field image encoding data includes labeled data and unlabeled data;
S104. reading a label mask based on the manually labeled data;
S105. extracting all connected target area lines from the label mask to obtain a contour of the label mask;
S106. performing random selection and transformation on the contour of the label mask to obtain a retained contour; and
S107. redrawing and generating a new label mask based on the retained contour, saving the new label mask, and completing the label mask conversion processing.

In this embodiment, the raw data collected and prepared for use come from the 11 types of grid-point wind field data in the Meteorological Information Comprehensive Analysis and Processing System (MICAPS). The 11 types of grid-point wind field data include longitude, latitude, U component of wind speed, and V component of wind speed, representing the vector wind speed information at each point in the atmospheric wind field. The wind speed and wind direction information are extracted through the processing of these data, serving as the basic features for model input.

In this embodiment, for the wind field vector decomposition, to convert the vector wind field data into an image data format suitable for deep learning models, the wind speed and wind direction at each grid point need to be calculated first. The wind speed (Speed) is calculated by taking the square root of the sum of the squares of U and V wind speed components, as shown in formula (1):

$$Speed = \sqrt{{U}^{2} + {V}^{2}} \qquad ( 1 )$$

where Speed represents the wind speed, U and V and represent the wind speed components.

In this embodiment, the wind direction Direction is calculated using the arctangent function (arctan) of the U and V components, and formula (2) is adjusted according to the quadrant of the wind speed to ensure the correctness of the direction angle:

$$Direction = \{ \begin{matrix}0 , & U = 0 , V \geq 0 \\ 90 , & U > 0 , V = 0 \\ 270 , & U < 0 , V = 0 \\ 180 , & U = 0 , V < 0 \\ arctan ( \frac{U}{V} ) \times \frac{180}{π} , & U > 0 , V > 0 \\ arctan ( − \frac{V}{U} ) \times \frac{180}{π} + 270 , & U ( 0 , V ) 0 \\ arctan ( − \frac{V}{U} ) \times \frac{180}{π} + 90 , & U > 0 , V < 0 \\ arctan ( \frac{U}{V} ) \times \frac{180}{π} + 180 , & U > 0 , V > 0\end{matrix} \qquad ( 2 )$$

In this embodiment, for the RGB channel conversion, the calculated wind speed and wind direction need to be mapped to RGB three-channel data in order to be used as input for the deep learning model. The specific mapping is shown in formulas (3), (4), and (5).

R channel represents the magnitude of the wind speed. For a grid point with a wind speed less than 14 m/s, the corresponding value of the R channel is set to 0; for a grid point with a wind speed greater than or equal to 14 m/s, the wind speed is mapped to a pixel value in the range [0, 255] using the following function:

$$\begin{matrix}{R}_{( i , j )} = \{ \begin{matrix}0 , {Speed}_{( i , j )} < 14 \\ \frac{255}{1 + {e}^{− Speed ( i , j ) + 20}} {Speed}_{( i , j )} \geq 14\end{matrix}\end{matrix} \qquad ( 3 )$$

G channel and B channel represent the wind direction. The wind direction only represents the direction angle, has no magnitude value, and thus cannot be directly used as an input feature for the model. Therefore, the wind direction is converted into coordinates (x, y) on a two-dimensional plane using the cosine and sine functions, and then these coordinates are mapped to the pixel values of the G and B channels. The conversion formulas are as follows:

$${G}_{( i , j )} = [ cos ( \frac{2 \times π \times {Direction}_{( i , j )}}{359} ) + 1 ] \times 127.5 \qquad ( 4 )$$

$${B}_{( i , j )} = [ sin ( \frac{2 \times π \times {Direction}_{( i , j )}}{359} ) + 1 ] \times 127.5 \qquad ( 5 )$$

where R_{(i,j)} represents a magnitude of wind speed at a position (i, j) of 11 types of grid-point wind field data from the MICAPS, which is mapped to a R channel value at a pixel (i, j) of a color image through encoding, G_{(i,j)} and B_{(i,j)} represent wind directions at the position (i, j) of 11 types of grid-point wind field data from the MICAPS, which are mapped to a G channel value and a B channel value at the pixel (i, j) of the color image through encoding, respectively, Speed represents a magnitude of the wind speed at the position (i, j) of 11 types of grid-point wind field data from the MICAPS, and Direction_{(i,j)} represents the wind direction at the position (i, j) of 11 types of grid-point wind field data from the MICAPS.

In this embodiment, the wind speed and the wind direction are calculated using the formulas. The wind speed data is mapped to the red channel (R channel), and the two components of the wind direction are mapped to the green (G channel) and blue (B channel), forming a standard RGB image data format, which is used as input for the semi-supervised deep learning model with cross pseudo-supervision.

In this embodiment, for label mask conversion, in image segmentation tasks, the label mask is a two-dimensional matrix image used to label different categories or feature regions. The label mask assigns a category label to each pixel, so that the semi-supervised deep learning model with cross pseudo-supervision can learn the correspondence between features and target regions. In this processing, the label mask is converted as follows:

Label mask reading: First, the label mask is read as a binary or multi-class mask image, where each pixel value corresponds to a label for a different category or region. The white area represents the target of interest, and the black area represents the background.

Contour detection of the label mask: All connected target region boundaries in the label mask are extracted using a contour detection algorithm. This step treats different connected regions in the mask as independent labels for analysis.

Random selection and conversion: To reduce the number of targets in the label mask or to perform downsampling based on specific requirements, random sampling is applied to the extracted contours.

Generation of a new label mask: Based on the retained contours, the new label mask is redrawn and generated. The randomly retained regions are marked on the new mask using contour drawing methods such as drawContours, resulting in a simplified outcome compared to the original mask.

Visualization and saving: The converted label mask is saved in PNG format for use during the training and evaluation of the semi-supervised deep learning model with cross pseudo-supervision.

In the step S2, the semi-supervised deep learning model with cross pseudo-supervision is constructed. The semi-supervised deep learning model with cross pseudo-supervision includes:
a first Swin-Unet network, configured to convert the preprocessing result and the label mask conversion result in the step S1 into a predicted first jet stream region mask;
a second Swin-Unet network, configured to convert the preprocessing result and the label mask conversion result in the step S1 into a predicted second jet stream region mask, where the first Swin-Unet network and the second Swin-Unet network adopt different initialization processes; and
a cross pseudo-supervision module, configured to generate a first pseudo label and a second pseudo label as mutual supervision signals based on the first jet stream region mask and the second jet stream region mask, thereby obtaining the image segmentation result, where each batch includes labeled and unlabeled data, and in each training batch, the semi-supervised deep learning model with cross pseudo-supervision updates weights using the labeled data while guiding the learning of the unlabeled data through pseudo labels.

In this embodiment, a batch refers to the amount of data processed in a single update (training iteration) of the semi-supervised deep learning model with cross pseudo-supervision. Labeled data refers to the jet stream axis data with true labels, used to directly compute the loss. Unlabeled data refers to data without true labels, with pseudo labels generated by another Swin-Unet network used as the supervision signal.

The first Swin-Unet network and the second Swin-Unet network have identical structures and both include:
an encoder, configured to partition the preprocessing result and the label mask conversion result in the step S1 into non-overlapping windows using a plurality of Swin Transformer modules to extract deep features, where a self-attention mechanism is applied within each window;
a bridging module, configured to connect an encoder and a decoder;
a decoder, configured to restore the extracted deep features to the same resolution as an input image through layer-wise upsampling, where the input image is the preprocessing result and the label mask conversion result in the step S1; and
an output layer, configured to convert an image output from the decoder into a predicted jet stream region mask using convolutional layers, where the jet stream region mask includes the first jet stream region mask and the second jet stream region mask.

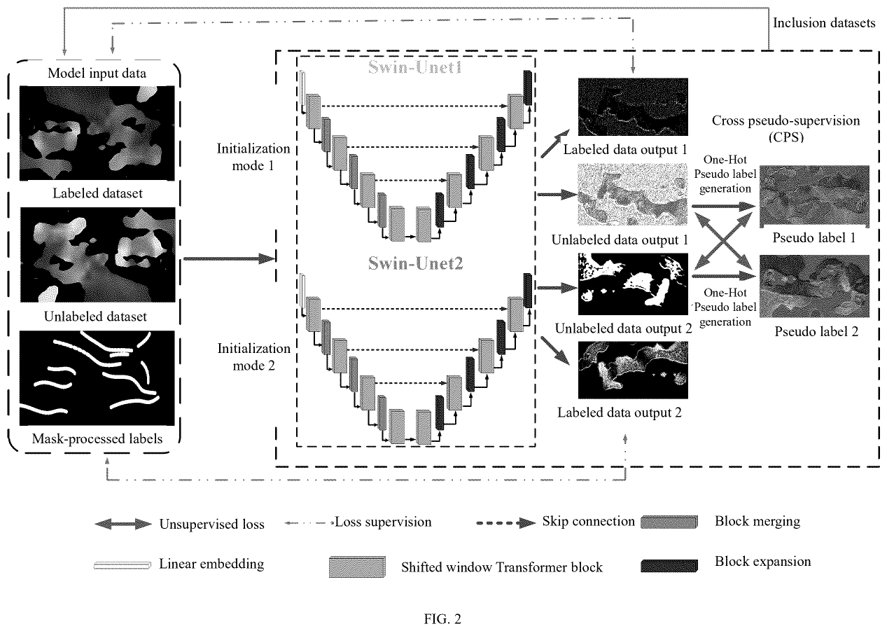

In this embodiment, as shown in FIG. 2, the semi-supervised deep learning model with cross pseudo-supervision is constructed using the deep learning framework PyTorch. The semi-supervised deep learning model with cross pseudo-supervision includes two Swin-Unet networks with different initializations and a cross pseudo-supervision (CPS) module. Both Swin-Unet networks with different initializations include an encoder, a bridge module, a decoder, and an output layer, and both Swin-Unet networks have the preprocessing result and the label mask conversion result in the step S1 as inputs.

In this embodiment, the two Swin-Unet networks with different initializations are used to generate intermediate results for labeled data and unlabeled data, which are then used for cross pseudo-supervision by the cross pseudo-supervision (CPS) module.

In this embodiment, the Swin-Unet network is a deep learning model that combines the Swin Transformer module with the U-Net architecture, primarily used for image segmentation tasks. The Swin Transformer module, by using the long-range dependency capture capability of the Transformer and the encoding-decoding structure of U-Net, can better handle complex feature segmentation tasks.

In this embodiment, the structure of the Swin-Unet network includes the following parts:

Encoder part: The encoder is responsible for layer-wise downsampling the input high-resolution image to extract features. Unlike the traditional U-Net, which uses convolutional neural networks (CNNs) for feature extraction, the Swin-Unet network adopts the Swin Transformer module. The Swin Transformer module partitions the input image into non-overlapping windows. A self-attention mechanism is applied within each window. This localized self-attention effectively reduces computational costs while preserving local information. As the number of layers increases, the window size gradually expands, enabling the capture of global dependencies at higher levels.

Bridge part: The bridge part in the Swin-Unet network serves to connect the encoder and decoder. In this part, the features (Features represent the numerical values of the input image, typically formed as feature maps after passing through a plurality of convolutional layers. These feature maps capture important information in the image, such as edges, textures, shapes, and other significant features.) are further processed through a plurality of Swin Transformer modules, so that the semi-supervised deep learning model with cross pseudo-supervision can capture long-range dependencies in the input image, and the expressive capability of the network is improved.

Decoder part: The decoder part restores the deep features extracted by the encoder to the same resolution as the original image through layer-wise upsampling, thereby gradually recovering spatial information. Each layer in the decoder combines the corresponding encoder layer output to form skip connections, which ensures that the semi-supervised deep learning model with cross pseudo-supervision retains sufficient detail during the upsampling process. Through these skip connections, the decoder section can effectively restore the spatial structure of the jet stream region.

Output part: The final layer of the Swin-Unet network converts the output of the decoder into the predicted jet stream region mask by using a convolutional layer. The output image, i.e., the jet stream region mask, where each pixel value represents whether the corresponding pixel belongs to the jet stream region. Typically, binary values are used: for example, a value of 1 (or 255) indicates that the pixel belongs to the jet stream region, and a value of 0 indicates that the pixel does not belong to the jet stream region. Each pixel in this output image indicates whether the pixel belongs to the jet stream region, which provides the foundation for subsequent cross pseudo-supervision.

In this embodiment, the idea of cross pseudo-supervision (CPS) is as follows: Two structurally identical Swin-Unet networks with different initializations generate pseudo labels. The pseudo labels of the networks are used as supervision signals. Each Swin-Unet network learns to process labeled data and also relies on the pseudo labels from the other Swin-Unet network to supervise the learning of unlabeled data, thereby improving generalization performance.

The loss function value is computed by the segmentation results outputted by the two differently initialized Swin-Unet networks with the labels. The loss function consists of a supervised loss term and an unsupervised loss term. During the consistency learning process, the cross pseudo-supervision structure is adopted, where “Output 1” and “Pseudo-label 2” construct one loss term, and “Output 2” and “Pseudo-label 1” construct another loss term. Each batch contains both labeled data and unlabeled data. For the unlabeled data, the corresponding one-hot pseudo labels are obtained through a Softmax operation, and these one-hot pseudo labels are used as supervision signals. For the labeled data, the outputs of the two neural networks are constrained by the supervised loss. The pseudo labels outputted by the cross pseudo-supervision are included in the training set, enhancing the generalization ability of the networks.

In this embodiment, during supervised learning, the cross-entropy loss function and the Dice loss function are two commonly used loss functions for semantic segmentation tasks. The cross-entropy loss function is used to measure the difference between the distribution of class probability predicted by the model and the distribution of one-hot encoded labels. The formula is as follows:

$${L}_{CE} = - {{\sum }_{i}}^{C} {y}_{i} log ( \hat{y} ) \qquad ( 6 )$$

The Dice loss function is based on the Dice coefficient, and the objective of the Dice loss function is to maximize the overlap between the predicted region and the true region. The formula for the Dice coefficient is as follows:

$$Dice = \frac{2 {\sum }_{i} {p}_{i} {g}_{i}}{{\sum }_{i} {p}_{i}^{2} + {\sum }_{i} {g}_{i}^{2}} \qquad ( 7 )$$

The cross-entropy loss function is suitable for pixel-level classification tasks, while the Dice loss function helps improve the region overlap accuracy of the segmentation results, especially performing well on imbalanced datasets. However, optimal results cannot be obtained by using only the cross-entropy loss function or the Dice loss function. Therefore, this application combines both loss functions as the loss function for supervised learning.

$${L}_{Sup} = λ {L}_{CE} + μ {L}_{Dice} \qquad ( 8 )$$

where L_{Stop} represents the supervised learning loss function of the semi-supervised deep learning model with cross pseudo-supervision, λ and μ represent weight coefficients, L_{CE} represents a cross-entropy loss function, L_{Dice} represents a Dice loss function, C represents a total number of categories, yᵢ represents a ground truth label, ŷ represents a probability of prediction belonging to category i, pᵢ represents the predicted probability, and pᵢ represents the ground truth label.

In the step S3, the semi-supervised deep learning model with cross pseudo-supervision is trained and evaluated by using the preprocessing result and the label mask conversion result in the step S1, and an image segmentation result is obtained according to the evaluated semi-supervised deep learning model with cross pseudo-supervision.

In this embodiment, 11 types of data from MICAPS are read, with the dataset spanning from 2019 to 2022. After wind vector decomposition and RGB channel conversion, 1000 images are generated, including the dataset, labels, and raw data. 10% of the data is allocated as the test set, while the remaining data is divided into training and validation sets in a ratio of 8:1. The semi-supervised deep learning model with cross pseudo-supervision maintains data independence during training and effectively evaluates the generalization ability of the model. This semi-supervised deep learning model with cross pseudo-supervision is trained using the training dataset. During training, the model adjusts the parameter weights by using samples from the test set to minimize the loss function.

In this embodiment, the performance of the semi-supervised deep learning model with cross pseudo-supervision is evaluated. The performance of the semi-supervised deep learning model with cross pseudo-supervision is evaluated using commonly used metrics in the field of image segmentation: Intersection over Union (IoU), Dice coefficient (Dice), and Precision (Pre). These metrics are used to measure the overlap, similarity, and accuracy between the predicted results and the ground truth labels. The Intersection over Union (IoU), also known as Jaccard index, calculates the ratio of the intersection to the union of the two sets of ground truth and predicted values, measures the degree of overlap between the predicted region and the true region, and focuses on the area of overlap between the prediction and the ground truth relative to the union area of the prediction and the ground truth. The Dice coefficient emphasizes the similarity between the predicted result and the ground truth, and measures the size of the intersection between the prediction and the ground truth. Precision is used to evaluate the accuracy of the semi-supervised deep learning model with cross pseudo-supervision, specifically the ratio of correctly predicted positive samples to all predicted positive samples.

In this embodiment, the semi-supervised deep learning model with cross pseudo-supervision is primarily applied to the automatic identification of jet stream axes in atmospheric wind fields, which addresses inefficiency, subjectivity, and high error rates associated with traditional manual drawing methods. This model effectively improves the generalization ability and recognition accuracy by the semi-supervised learning framework based on deep learning and the cross pseudo-supervision (CPS) strategy. This technology overcomes the limitations of traditional manual drawing and fully supervised learning in terms of time, human resources, and data dependency, and provides significant application value in the fields of atmospheric science and aviation safety. The semi-supervised deep learning model with cross pseudo-supervision has the following specific applications.

Meteorological Data Analysis and Jet Stream Monitoring: This model enables the rapid identification of the location and intensity of atmospheric jet streams, providing precise weather analysis assistance to meteorologists and improving the accuracy of weather forecasting. The model is particularly suitable for analyzing upper-level wind fields and monitoring extreme weather events associated with jet streams, such as blizzards, heavy rainfall, and other severe weather conditions.

Meteorological Emergency Response and Aviation Support: The model identifies the impact of jet stream axes on airline routes, and optimizes flight path planning to reduce turbulence and fuel consumption in strong wind zones. This model provides decision-making support for meteorological emergency responses and enhances early warning capabilities during severe weather conditions.

High-Precision Weather Forecasting: Jet stream axes are an important component of meteorological systems and have a significant impact on frontal movements, heavy rainfall, and typhoon paths. The model automatically extracts jet stream axes from wind fields, provides meteorologists with accurate upper-level wind field charts, and significantly improves the accuracy of short-term and medium-term weather forecasts.

Automated Meteorological System Integration: The model may be integrated into existing meteorological data processing systems (such as MICAPS), which replaces traditional manual plotting processes, thereby enhancing the automation and real-time processing of data.

In the step S4, the jet stream axis is extracted by using an eight-neighborhood connection algorithm based on a jet stream center axis point according to the image segmentation result. The step S4 is implemented as follows:
S401. based on the image segmentation result, locating a starting pixel, where only one neighboring pixel in eight-neighborhood around the starting pixel has a color value; in this step, the starting pixel is randomly selected, with the goal of locating a pixel that meets the criteria (the criterion: only one neighboring pixel in the eight-neighborhood around the starting pixel has a color value);
S402. traversing the eight-neighborhood of the starting pixel, preferentially selecting a neighboring pixel that is closest to a current point and has not been accessed, and marking the neighboring pixel as accessed;
S403. with the starting pixel as a center, determining whether all neighboring pixels have been traversed, if so, sequentially adding each neighboring pixel to a set of connected jet stream axis center points and proceeding to step S404, and otherwise, returning to the step S402; and
S404. based on the jet stream axis center point set, drawing a jet stream line to complete the extraction of the jet stream axis.

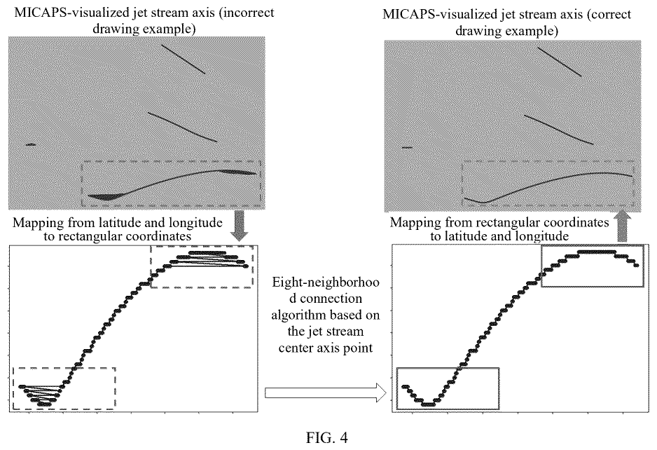

In this embodiment, as shown in FIG. 4, when the skeleton-extracted jet stream axis center point set are connected to draw the jet stream axis lines, the default bottom-to-top connection method results in abnormal axis lines, as shown in the green dashed box in the figure. After the transformation to Cartesian coordinates, the abnormal axis lines result in the scatter point connection shown in the red dashed box. To solve this problem, the present application proposes an eight-neighborhood connection algorithm based on jet stream center axis points, which ensures that scatter points in the image are connected in spatial order, rather than randomly. The core of the algorithm is as follows: first, a suitable starting pixel is located, that is, only one neighborhood within an eight-neighborhood around the pixel has a color value to ensure uniqueness and orderliness of connection; after the starting pixel is found, the algorithm preferentially selects a neighboring pixel that is closest to a current point and has not been accessed by traversing the eight-neighborhood of the pixel, and marking the neighboring pixel as accessed; then, the process is repeated with the neighboring pixel as a center, and each neighboring pixel is sequentially added to a connected point set.

In this embodiment, a direction array is used to represent eight possible neighborhoods, including upper, lower, left, right, and four diagonal directions, to improve efficiency of the algorithm, thereby enabling rapid access to adjacent pixels. The entire process traverses all pixels through recursion and iteration to ensure that a connection order of the points is consistent with a spatial distribution thereof, effectively avoiding occurrence of random connection. This method not only simplifies a connection process of jet stream center axis points but also ensures consistency of spatial structure during conversion to a general data format, thereby solving random connection of scattered points in an image. The effect is shown in a red solid-line box and a blue dashed-line box in the figure.

In summary, the present application solves the problems of low efficiency and poor generalization ability of traditional jet stream axis extraction methods by combining semi-supervised learning and an eight-neighborhood connection algorithm based on the jet stream center axis point, while reducing dependence on labeled data and improving the accuracy and robustness of jet stream axis recognition.

What is claimed is:

1. A method for automatically extracting a jet stream axis based on semi-supervised learning with cross pseudo-supervision, comprising the following steps:
S1. preprocessing acquired 11 types of grid-point wind field data and performing label mask conversion on manually labeled data;
S2. constructing a semi-supervised deep learning model with cross pseudo-supervision;
S3. training and evaluating the semi-supervised deep learning model with cross pseudo-supervision by using a preprocessing result and a label mask conversion result in the step S1, and obtaining an image segmentation result according to the evaluated semi-supervised deep learning model with cross pseudo-supervision; and
S4. extracting the jet stream axis by using an eight-neighborhood connection algorithm based on a jet stream center axis point according to the image segmentation result.

2. The method for automatically extracting the jet stream axis based on semi-supervised learning with cross pseudo-supervision according to claim 1, wherein the S1 comprises the following steps:
S101. acquiring 11 types of grid-point wind field data;
S102. calculating wind speed and wind direction for each grid point, wherein the accuracy of a direction angle is determined by adjusting a quadrant of the wind speed;
S103. mapping the calculated wind speed and wind direction to RGB three-channel data, obtaining wind field image encoding data, and completing preprocessing of wind field processing data, wherein the R channel data represents a magnitude of the wind speed mapped to a value range of a R channel in a color image through encoding, the G channel data and the B channel data represent wind directions mapped to value ranges of a G channel and a B channel in a color image through encoding, respectively, and the wind field image encoding data comprises labeled data and unlabeled data;
S104. reading a label mask based on the manually labeled data;
S105. extracting all connected target area lines from the label mask to obtain a contour of the label mask;
S106. performing random selection and transformation on the contour of the label mask to obtain a retained contour; and
S107. redrawing and generating a new label mask based on the retained contour, saving the new label mask, and completing the label mask conversion processing.

3. The method for automatically extracting the jet stream axis based on semi-supervised learning with cross pseudo-supervision according to claim 2, wherein an expression for the wind speed is as follows:
$$Speed = \sqrt{{U}^{2} + {V}^{2}}$$
wherein Speed represents the wind speed, and U and V represent wind speed components;
an expression for the wind direction is as follows:
$$Direction = \{ \begin{matrix}0 , & U = 0 , V \geq 0 \\ 90 , & U > 0 , V = 0 \\ 270 , & U < 0 , V = 0 \\ 180 , & U = 0 , V < 0 \\ arctan ( \frac{U}{V} ) \times \frac{180}{π} , & U > 0 , V > 0 \\ arctan ( − \frac{V}{U} ) \times \frac{180}{π} + 270 , & U ( 0 , V ) 0 \\ arctan ( − \frac{V}{U} ) \times \frac{180}{π} + 90 , & U > 0 , V < 0 \\ arctan ( \frac{U}{V} ) \times \frac{180}{π} + 180 , & U > 0 , V > 0\end{matrix}$$
wherein Direction represents the wind direction.

4. The method for automatically extracting the jet stream axis based on semi-supervised learning with cross pseudo-supervision according to claim 3, wherein mapping the calculated wind speed and wind direction to the RGB three-channel data is specifically as follows:
mapping the calculated wind speed and wind direction to the RGB three-channel data by using the following formula:
$${R}_{( i , j )} = \{ \begin{matrix}0 , {Speed}_{( i , j )} < 14 \\ \frac{255}{1 + {e}^{− {Speed}_{( i , j )} + 20}} {Speed}_{( i , j )} \geq 14\end{matrix}$$
$${G}_{( i , j )} = [ cos ( \frac{2 \times π \times {Direction}_{( i , j )}}{359} ) + 1 ] \times 127.5$$
$${B}_{( i , j )} = [ sin ( \frac{2 \times π \times {Direction}_{( i , j )}}{359} ) + 1 ] \times 127.5$$
wherein R_{(i,j)} represents a magnitude of wind speed at a position (i, j) of 11 types of grid-point wind field data from the MICAPS, which is mapped to a R channel value at a pixel (i, j) of a color image through encoding, G_{(i,j)} and B_{(i,j)} represent wind directions at the position (i, j) of 11 types of grid-point wind field data from the MICAPS, which are mapped to a G channel value and a B channel value at the pixel (i, j) of the color image through encoding, respectively, Speed_{(i,j)} represents a magnitude of the wind speed at the position (i, j) of 11 types of grid-point wind field data from the MICAPS, and Direction_{(i,j)} represents the wind direction at the position (i, j) of 11 types of grid-point wind field data from the MICAPS.

5. The method for automatically extracting the jet stream axis based on semi-supervised learning with cross pseudo-supervision according to claim 1, wherein the semi-supervised deep learning model with cross pseudo-supervision comprises:
a first Swin-Unet network, configured to convert the preprocessing result and the label mask conversion result in the step S1 into a predicted first jet stream region mask;
a second Swin-Unet network, configured to convert the preprocessing result and the label mask conversion result in the step S1 into a predicted second jet stream region mask, wherein the first Swin-Unet network and the second Swin-Unet network adopt different initialization processes; and
a cross pseudo-supervision module, configured to generate a first pseudo label and a second pseudo label as mutual supervision signals based on the first jet stream region mask and the second jet stream region mask, thereby obtaining the image segmentation result, wherein each batch comprises labeled and unlabeled data, and in each training batch, the semi-supervised deep learning model with cross pseudo-supervision updates weights using the labeled data while guiding the learning of the unlabeled data through pseudo labels.

6. The method for automatically extracting the jet stream axis based on semi-supervised learning with cross pseudo-supervision according to claim 5, wherein the first Swin-Unet network and the second Swin-Unet network have identical structures and both comprise:
an encoder, configured to partition the preprocessing result and the label mask conversion result in the step S1 into non-overlapping windows using a plurality of Swin Transformer modules to extract deep features, wherein a self-attention mechanism is applied within each window;
a bridging module, configured to connect an encoder and a decoder;
a decoder, configured to restore the extracted deep features to the same resolution as an input image through layer-wise upsampling, wherein the input image is the preprocessing result and the label mask conversion result in the step S1; and
an output layer, configured to convert an image output from the decoder into a predicted jet stream region mask using convolutional layers, wherein the jet stream region mask comprises the first jet stream region mask and the second jet stream region mask.

7. The method for automatically extracting the jet stream axis based on semi-supervised learning with cross pseudo-supervision according to claim 5, wherein an expression for a supervised learning loss function of the semi-supervised deep learning model with cross pseudo-supervision is as follows:
$${L}_{Sup} = λ {L}_{CE} + μ {L}_{Dice}$$
$${L}_{CE} = - {{\sum }_{i}}^{C} {y}_{i} log ( \hat{y} )$$
Wherein L_{Stop} represents the supervised learning loss function of the semi-supervised deep learning model with cross pseudo-supervision, λ and μ represent weight coefficients, L_{CE} represents a cross-entropy loss function, L_{Dice} represents a Dice loss function, C represents a total number of categories, yᵢ represents a ground truth label, and ŷ represents a probability of prediction belonging to category i.

8. The method for automatically extracting the jet stream axis based on semi-supervised learning with cross pseudo-supervision according to claim 1, wherein the S4 comprises the following steps:
S401. based on the image segmentation result, locating a starting pixel, wherein only one neighboring pixel in eight-neighborhood around the starting pixel has a color value;
S402. traversing the eight-neighborhood of the starting pixel, preferentially selecting a neighboring pixel that is closest to a current point and has not been accessed, and marking the neighboring pixel as accessed;
S403. with the starting pixel as a center, determining whether all neighboring pixels have been traversed, if so, sequentially adding each neighboring pixel to a set of connected jet stream axis center points and proceeding to step S404, and otherwise, returning to the step S402; and
S404. based on the jet stream axis center point set, drawing a jet stream line to complete the extraction of the jet stream axis.
